(19) United States
(12) Patent Application Publication
(10) Pub. No.: US 2026/0090549 A1
(43) Pub. Date: Apr. 2, 2026

(54) DOUGH TRANSFER DEVICE

(71) Applicant: KÖNIG MASCHINEN GESELLSCHAFT M.B.H., Graz (AT)

(72) Inventors: Robert SAUSENG, St. Radegund (AT); Kristijan VUGRINEC, Kirchberg an der Raab (AT)

(21) Appl. No.: 19/112,196

(22) PCT Filed: Sep. 15, 2023
(86) PCT No.: PCT/AT2023/060324

§ 371 Date: Mar. 14, 2025

(30) Foreign Application Priority Data
Sep. 16, 2022 (AT) A 50712/2022

(51) Int. Cl. A21C 9/08; A21C 5/04; A21C 7/00

(52) U.S. Cl. CPC A21C 9/085; A21C 5/04; A21C 7/005

(57) ABSTRACT

A device for transferring pieces of dough includes a weighing device, in which dough can be weighed into dough portions with a defined weight and/or volume and can be discharged as dough products, and a working device, by which the portioned dough products can be processed, wherein the weighing device is positioned relative to the working device such that a dough product which has been portioned by the weighing device can be transferred to the working device in a transfer region. A release device is arranged in the transfer region between the weighing device and the working device and is designed to be movable in an oscillating manner and such that dough products which are transferred from the weighing device to the working device can be brought into contact with the release device, can be discharged from the weighing device, and can be introduced into the working device.

### CROSS REFERENCES

This application is a U.S. National Phase Application of International Application No. PCT/AT2023/060324 filed Sep. 15, 2023, which claims priority to Austrian Application No. A50712/2022 filed Sep. 16, 2022, the disclosures of each of which are hereby incorporated by reference herein in their entirety.

### TECHNICAL FIELD

The present disclosure relates to a device for transferring pieces of dough and, more particularly, to a device for transferring dough while reducing contact with the dough.

### BACKGROUND

There are numerous devices in the prior art with which dough is processed in kneading devices or drums. There are also numerous weighing devices in the prior art, e.g. weighing drums, in which dough can be divided into smaller portions of a defined weight. It is necessary to transport the dough, or pieces thereof, from one processing station to the next in bakeries. There are numerous ways of transferring dough in the prior art that are necessary for the production of bread and pastries. The devices from the prior art include conveyor belts and rollers that receive and deliver the dough.

AT 518778 A1 discloses such a device from the prior art. The pieces of dough received from the weighing device are transferred therein by a conveyor belt between a kneading drum and a dough drum.

One disadvantage with the systems from the prior art is that the pieces of dough remain in contact with the conveyor belts or rollers for a relatively long time. The pieces of dough frequently adhere to the belts or rollers and may remain stuck to them, or the individual pieces may become smaller and therefore lighter when a part thereof is left behind. They are also often deformed. Oil or flour can help to some extent with the devices from the prior art. The use of oil or flour, however, has the disadvantage that all of the pieces of dough are more or less subjected to the same separating means, which has a negative effect on the flavor and further processing of the dough, as well as the appearance of the finished product. Furthermore, the belts used in the prior art are complex and therefore expensive, and are complicated to maintain, because the belts must be removed from the machines in order to clean them and their rollers.

The object of the present disclosure is to therefore create a device for transferring pieces of dough, in which they are in contact with the transfer means as little as possible, and no separating means are necessary.

### SUMMARY

The present disclosure provides that there is an oscillating separator in the transition area between the weighing device and the kneading device, which is designed and placed such that the pieces of dough transferred from the weighing device to the kneading device come in contact with the separator, which removes them from the weighing device and transfers them to the processing station, in particular the kneading device.

The advantage with the device obtained with the present disclosure is that there is no need for a conveyor belt with complex tensioners and belt guides. By eliminating this complicated structure, costs are reduced and cleaning of the individual parts is simplified, while preventing the dough, or pieces thereof, from adhering to the separator and thus having a negative effect on the weight or finishing process. The oscillation of the separator also increases the speed of the individual processing steps, resulting in a more efficient overall production process.

Particularly advantageous embodiments of the device are defined in greater detail by the features of the dependent claims.

A particularly preferred embodiment of the device is obtained when the separator has a dough blade that oscillates about a pivotal axis and is designed and placed such that pieces of dough come in contact with the dough blade in the transfer area between the weighing device and the processing station, in particular the kneading device, and are then removed from the weighing device and placed in the processing station, in particular the kneading device.

In another embodiment, the separator has a linear drive that causes a slider to oscillate.

The pieces of dough can be readily conveyed from the weighing device to the processing station, in particular the kneading device, when the kneading device is below the weighing device and the separator, in particular the dough blade or slider, is placed such that the oscillation thereof, in particular the pivoting of the dough blade, pushes the pieces of dough toward the processing station, in particular the kneading device.

The separator, in particular the dough blade or slider, can advantageously have a contact plate on the end facing the weighing device, which comes in contact with the dough when the separator oscillates.

To further prevent the dough from adhering to the separator, in particular the contact blade, can have a dough-repellent and/or non-stick coating or be made of a dough-repellent and/or non-stick material.

In an advantageous embodiment of the device, the processing station is a kneading device that contains a rotating drum with a number of kneading chambers distributed evenly along the circumference of the drum.

Another advantageous embodiment is obtained when the weighing device has a drum with a number of chambers containing plungers that can move back and forth therein, and the drum can be moved between a weighing position, in which the dough can be placed in the chambers, and a transfer position, where it is rotated or pivoted into the transfer area.

Depending on the consistency of the dough and the size of the pieces thereof, they can be effectively removed from the weighing device when the separator bears on the outer surface of the weighing device, in particular the outer surface of the weighing drum in the transfer area, or the end of the separator facing the weighing device is at a distance of 0.05 mm to 10 mm from the weighing device, in particular the weighing drum forming the weighing device.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views:

FIG. 1 shows a schematic sectional view of a first embodiment of the device obtained with the present disclosure, which has a dough blade, and

FIG. 2 shows a second embodiment, which has a separator slider.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

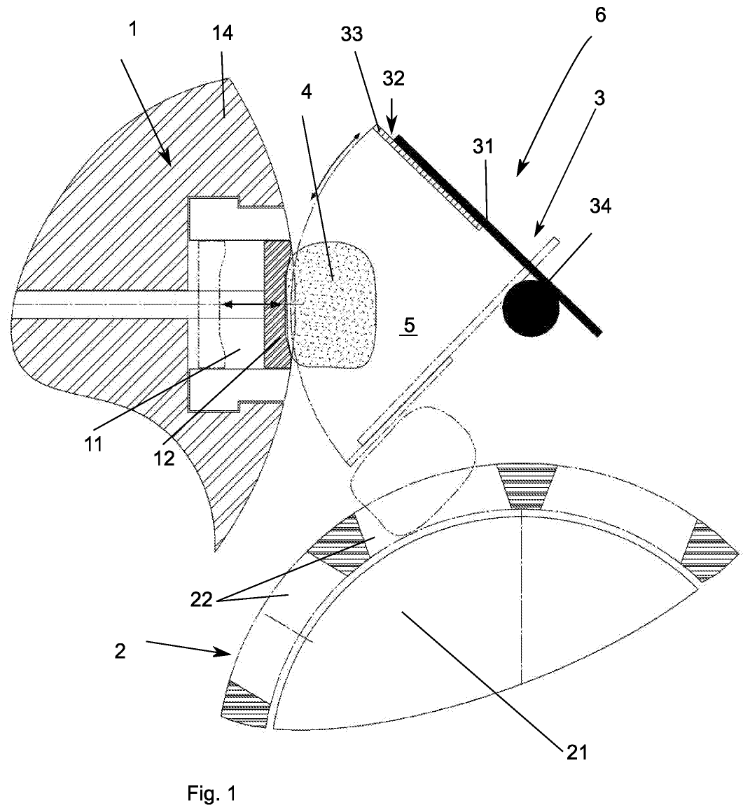

A first embodiment of the device for transferring dough obtained with the present disclosure is shown in FIG. 1. The device has a weighing device 1 in which the dough is portioned into pieces of dough 4 with a defined weight and/or volume. The device also has a processing station in the form of a kneading device 2, in which the pieces of dough 4 obtained from the weighing device 1 are placed and worked, i.e. kneaded and shaped. There is a transfer area 5 between the weighing device 1 and the kneading device 2 in which the pieces of dough 4 obtained from the weighing device 1 are transferred to the kneading device 2. A separator 6 is placed in the transfer area 5 between the weighing device 2 and the kneading device 2. The separator 6 has a dough blade 3 in the embodiment shown in FIG. 1. This dough blade 3 has an elongated body 31 that pivots, or can be tilted, about a pivotal axis 34. This pivotal movement is indicated by the arrow in FIG. 1.

The dough blade 3 is placed in the transfer area 5, as shown in FIG. 1, such that it comes in contact with the pieces of dough 4 at the outer surface of the weighing device 1 when it pivots about the pivotal axis 34, conveying it from the weighing device 1 into the kneading device 2. The movement of the piece of dough 4 by the dough blade 3 when it enters the kneading device 2 is indicated by the line composed of dashes and dots in FIG. 1.

The weighing device 1 in the embodiment shown in FIG. 1 has a weighing drum 14 that contains a number of chambers 11 in which weighing plungers 12 move back and forth along the arrows shown in FIG. 1. The weighing drum 14 is shaped like a drum with weighing chambers 11 that are evenly distributed over its circumference. Dough is pushed by a slider into the chambers 11 in the weighing device 1 when the weighing plunger 12 is retracted, as indicated by the line composed of dots and dashes in FIG. 1, and depending on the position of this weighing plunger 12, pushes a defined portion of dough into the weighing drum 14, or the receiving chamber 11. These portions of dough 4 are then transported toward the transfer area 5 by the weighing drum 14, which continues to rotate thereby. As the weighing drum 14 rotates, the plunger 12 extends toward the outer surface of the weighing drum 14, where it reaches its full extension at the transfer area 5. The dough blade 3 is pivoted in the transfer area 5, enters the weighing chamber 11 in the weighing drum 14, bearing lightly on the plunger 12, comes in contact with the piece of dough 4, and moves it toward the kneading device 2. This entering of the dough blade 3 into the weighing chamber 11 has the advantage that the blade 33 can be fully extended, thus advantageously separating the entire piece of dough 4, reliably extracting it in its entirety.

The kneading device 2 contains a kneading drum 21 that rotates about its axis, as shown in FIG. 1. This kneading drum 21 has a number of kneading chambers 22 that are evenly distributed about the circumference of the drum 21. The pieces of dough 4 are removed from the weighing device 1 by the dough blade 3 in the transfer area 5, as shown in FIG. 1, and placed in the kneading chambers 22 in the drum 21. The pivotal movement of the dough blade 3 separates the pieces of dough 4 from the plunger 12 in the weighing device 1, such that they are fully separated from plunger 12 and placed in the kneading device 2. The pivotal movement of the dough blade 3 allows it to move very quickly, and the pieces of dough 4 are only in contact therewith for a short time, such that they are practically slapped, or flung, into the kneading device 2. This has the major advantage that the contact between the pieces of dough 4 and the blade 3 is kept to a minimum, thus preventing the pieces of dough 4 from adhering to the blade 3.

As shown in FIG. 1, the dough blade 3 in this preferred embodiment has an elongated body 31. The end 32 of the blade 3 facing the weighing device 1 is elongated, such that the distance from the pivot axis 34 to the blade 3 can depend on the size of the piece of dough 4, to prevent the pivot axis 34 from coming in contact with the dough. A contact plate 33 can preferably be placed on the end 32 of the blade 3 facing the weighing device 1, as shown in FIG. 1. This contact plate 33 can be attached with threaded fasteners to the body 31 of the dough blade 3 such that it can be replaced as needed. The contact plate 33 comes in contact with the piece of dough 4 when the blade 3 pivots, and can therefore have a positive effect on the contact between the dough 4 and the blade 3, depending on its design.

In the preferred embodiment of the device obtained with the present disclosure shown in FIG. 1, the end 32 of the dough blade 3 facing the weighing device 1 bears on the outer surface thereof such that a part of the contact plate 33, or the blade 3, enters the chamber 11 in the weighing device 1, or bears on the surface of the weighing device 1 as it pivots past it. In another embodiment, the end 32 facing the weighing device 1, or the plate 33 on the blade 3, comes close to the weighing device 1, e.g. at a distance of 0.05 mm to 10 mm thereto. This results in an optimal removal of the pieces of dough 4 from the weighing device 1.

In a preferred embodiment, not shown in the drawings, the pivotal axis of the dough blade 3 can be adjusted, such that blade can be adjusted to the size of the pieces of dough 4, or to the placement of the weighing device in relation to the kneading device 2.

As shown in FIG. 1, the pivot axis 34 for the dough blade 3 can be parallel to the weighing device 1, or the weighing drum 14, and/or parallel to the kneading drum 21, or its axis. As shown in FIG. 1, the kneading drum 21, or the kneading device 2, is below the weighing device 1 or weighing drum 14, such that the pieces of dough 4 are removed in the transfer area 5 by the dough blade 3 from the weighing device 1 and drop into the kneading drum 21 or kneading device 2 due to gravity. This reduces the amount of force required for the dough blade 3 to move the pieces of dough 4 into the kneading device 2.

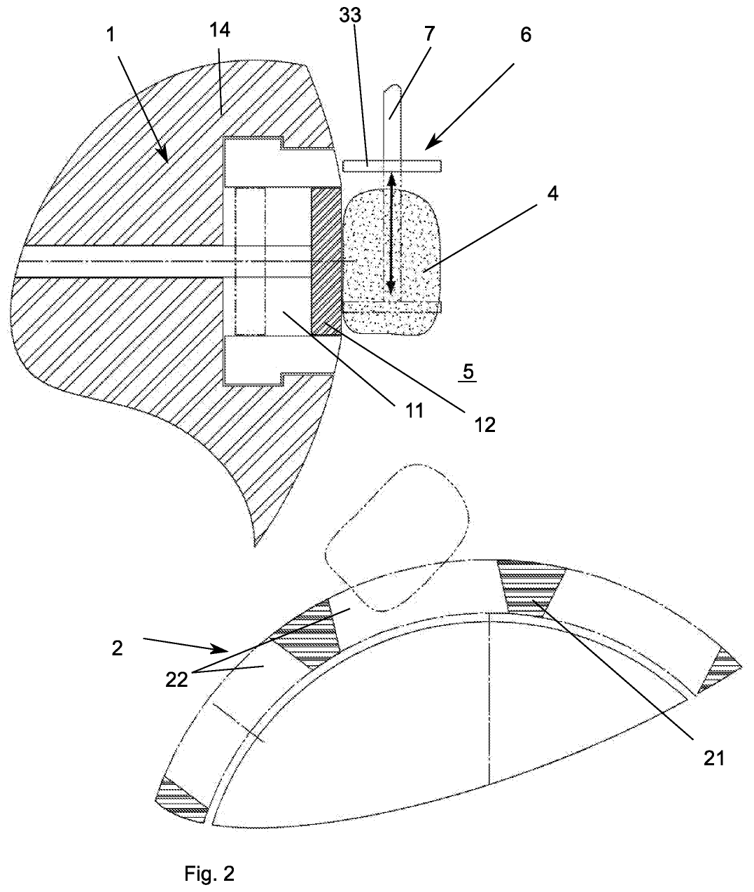

A second embodiment of the device obtained with the present disclosure is shown schematically in FIG. 2. The separator 6 has a linear drive, not shown in FIG. 2, to which a slider 7 is attached. This slider 7 is oscillated by the linear drive. The slider 7 therefore moves toward the exit in the weighing device 1, in the direction indicated by the arrow in FIG. 2, where it comes in contact with the piece of dough 4. The piece of dough 4 is then pushed out of the weighing device 1 and moved or slid toward the processing station formed by the kneading device 2, where it enters one of the kneading chambers 22 in the kneading device 2. The separator 6 is placed such that the slider 7 oscillates tangentially to the weighing drum 14 forming the weighing device 1, thus fully removing the pieces of dough 4 from the weighing chamber 11.

As with FIG. 1, the weighing device 1 in FIG. 2 can also contain a weighing drum 14 with a number of chambers 11, in each of which a plunger 12 can move back and forth in the direction of the arrow in FIG. 2.

The kneading device 2 in FIG. 2 also has a kneading drum 21 that rotates about its axis, like that in FIG. 1. This kneading drum 21 has a number of chambers 22 that are evenly distributed about the circumference of the kneading drum 21.

The contact plate 33 can also have a non-stick coating or be made of a material that the pieces of dough 4 do not adhere to. This can be a piece of the material forming a conveyor belt, which is glued to the contact plate 33.

Instead of conveying the pieces of dough 4 downward with the dough blade 3 or slider 7, they can also be moved horizontally and/or vertically by the blade 3 or slider 7, from the weighing device 1 to the kneading device 2.

The processing station can also differ from those in the prior art. The processing station can also be a proofing cabinet, oven, or some other device used for baking, with which the consistency or character of the dough, or pieces of dough, is altered.

There can also be a conveyor belt between the separator 6 and the processing station, or kneading device 2, with which the pieces of dough 4 are transported to the processing station. The pieces of dough 4 can thus be removed from the weighing device 1 with the separator 6 and placed on the conveyor belt, which then transports them to the processing station.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

1. A device for transferring pieces of dough, comprising
a weighing device, in which dough can be weighed out and removed from the weighing device as pieces of dough, and
a processing station, with which the pieces of dough can be processed;
wherein the weighing device is configured in relation to the processing station, such that the pieces of dough can be transferred in a transfer area from the weighing device to the processing station; and
wherein a separator is configured in the transfer area between the weighing device and the processing station, wherein the separator is configured to oscillate, wherein the separator is configured such that the pieces of dough transferred in the transfer area from the weighing device to the processing station come in contact with the separator, are removed from the weighing device and placed in the processing station.

2. The device according to claim 1, wherein the separator comprises a dough blade configured to pivot about a pivotal axis, wherein the dough blade is configured such that the pieces of dough transferred from the weighing device to the processing station come in contact with the dough blade in the transfer area, are removed from the weighing device and then placed in the processing station.

3. The device according to claim 1, wherein the separator comprises a linear drive and a slider that is moved back and forth by the linear drive.

4. The device according to claim 1, wherein the processing station, is configured below the weighing device wherein the separator is configured such that when the separator oscillates the pieces of dough are conveyed toward the processing station.

5. The device according to claim 1, wherein the separator comprises a contact plate which is on an end of the separator facing the weighing device and comes in contact with the pieces of dough when the separator oscillates.

6. The device according to claim 1, wherein the separator comprises a dough-repellent and/or non-stick coating, or is made of a dough-repellent and/or non-stick material.

7. The device according to claim 1, wherein the processing station comprises a kneading device wherein the kneading device comprises a kneading drum configured to rotate about an axis, wherein the kneading drum comprises a number of chambers evenly distributed about a circumference of the kneading drum.

8. The device according to claim 1, wherein the weighing device comprises a weighing drum comprising a number of chambers, each of the number of chambers having a plunger configured to move back and forth in the chamber, wherein the weighing drum is configured to move between a weighing position, in which the dough can be placed in the number of chambers and a transfer position in the transfer area.

9. The device according to claim 1, wherein the separator bears on an outer surface of the weighing device in the transfer area.

10. The device according to claim 9, wherein the weighing device comprises a weighing drum and wherein the separator bears on an outer surface of the weighing drum in the transfer area.

11. The device according to claim 1, wherein an end of the separator facing the weighing device is adjacent an outer surface of the weighing device.

12. The device according to claim 9, wherein the weighing device comprises a weighing drum and wherein an end of the separator facing the weighing device is adjacent an outer surface the weighing drum.

13. The device according to claim 10, wherein the end of the separator facing the weighing device is at a distance of 0.05 mm to 10 mm from the outer surface of the weighing device.

14. The device according to claim 5, wherein at least the contact plate of the separator comprises a dough-repellent and/or non-stick material.
